(19) United States
(12) Patent Application Publication
(10) Pub. No.: US 2011/0153328 A1
(43) Pub. Date: Jun. 23, 2011

(54) OBSCENE CONTENT ANALYSIS APPARATUS AND METHOD BASED ON AUDIO DATA ANALYSIS

(75) Inventors: Jae Deok LIM, Daejeon (KR); Seung Wan HAN, Gwangju (KR); Byeong Cheol CHOI, Daejeon (KR); Byung Ho CHUNG, Daejeon (KR)

(73) Assignee: Electronics and Telecommunications Research Institute, Daejeon (KR)

(21) Appl. No.: 12/948,368

(22) Filed: Nov. 17, 2010

(30) Foreign Application Priority Data
Dec. 21, 2009 (KR) 10-2009-0128362
Aug. 31, 2010 (KR) 10-2010-0084657

(51) Int. Cl. G10L 15/00

(52) U.S. Cl. 704/251; 704/E15.001

(57) ABSTRACT

Provided is an obscene content analysis apparatus and method. The obscene content analysis apparatus includes a content input unit that receives content, an input data buffering unit that buffers the received content, wherein buffering is performed on content corresponding to a length of a previously set analysis section or a length longer than the analysis section, an obscenity analysis determining unit that determines whether or not the analysis section of audio data extracted from the buffered content is obscene by using a previously generated audio-based obscenity determining model and marks the analysis section with an obscenity mark when the analysis section is determined as obscene, a reproduction data buffering unit that accumulates and stores content in which obscenity has been determined by the obscenity analysis determining unit, and a content reproducing unit that reproduces the content while blocking the analysis section marked with the obscenity mark.

### CROSS-REFERENCE TO RELATED APPLICATION

This application claims priority to and the benefit of Korean Patent Application Nos. 10-2009-0128362 filed Dec. 21, 2009, and 10-2010-0084657 filed Aug. 31, 2010, the disclosure of which is incorporated herein by reference in its entirety.

### BACKGROUND

1. Field of the Invention

The present invention relates to an obscene content analysis apparatus and method, and more particularly, to an obscene content analysis apparatus and method that analyze and block obscene content.

2. Discussion of Related Art

With the wide propagation of the Internet, a variety of multimedia contents are being distributed through the Internet. Among the multimedia contents, many obscene contents also exist. The obscene contents can be provided regardless of user's intentions, and particularly, youth are frequently exposed to the obscene contents, leading to social problems.

A technique of detecting the obscene content by determining whether or not the content is obscene using an image of the content has been conventionally used. In this technique, in order to determine whether or not the content is obscene, whether or not each frame is obscene is determined by analyzing the content of each frame.

However, the conventional technique uses an image of the content and analyzes each frame in order to determine the obscene content, and thus it is inefficient in speed or system resource cost. Further, it is difficult to provide the content to a user in real time.

Therefore, there is a need for a technique that can more efficiently block obscene parts of content during reproduction of the content, provide the content to a user in real time, and selectively provide unobscene parts of content since a single content may include both obscene parts and unobscene parts.

### SUMMARY OF THE INVENTION

The present invention is directed to an obscene content analysis apparatus and method in which audio data of the content is divided into a plurality of sections, it is determined whether or not each section is obscene, a section having obscenity is marked with an obscenity mark, and the content is provided in real time while blocking a part of the content with an obscenity mark during reproduction of the content.

One aspect of the present invention provides an obscene content analysis apparatus based on audio data analysis, including: a content input unit that receives content; an input data buffering unit that buffers the received content, wherein buffering is performed on content corresponding to a length of a previously set analysis section or a length longer than the analysis section; an obscenity analysis determining unit that determines whether or not the analysis section of audio data extracted from the buffered content is obscene by using a previously generated audio-based obscenity determining model and marks the analysis section with an obscenity mark when the analysis section is determined as obscene; a reproduction data buffering unit that accumulates and stores content in which obscenity has been determined by the obscenity analysis determining unit; and a content reproducing unit that reproduces the content while blocking the analysis section marked with the obscenity mark.

Another aspect of the present invention provides a method of analyzing obscene content based on audio data, including: receiving content; buffering the received content, wherein buffering is performed on content corresponding to a length of a previously set analysis section or a length longer than the analysis section; extracting audio data from the buffered content; determining whether or not the analysis section of the audio data extracted from the content is obscene by using a previously generated audio-based obscenity determining model; marking the analysis section with an obscenity mark when the analysis section is determined as obscene; accumulating and storing content in which obscenity has been determined; and reproducing the content while blocking the analysis section marked with the obscenity mark.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a configuration diagram illustrating an obscene content analysis apparatus based on audio data analysis according to an exemplary embodiment of the present invention;

FIG. 2 is a view for explaining a method of dividing the analysis section into the analysis subsections and analyzing the obscene content according to an exemplary embodiment of the present invention;

FIG. 3 is a flowchart for explaining an obscene content analysis method based on audio data analysis according to an exemplary embodiment of the present invention; and

FIG. 4 is a configuration diagram of an audio-based obscenity determining model according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

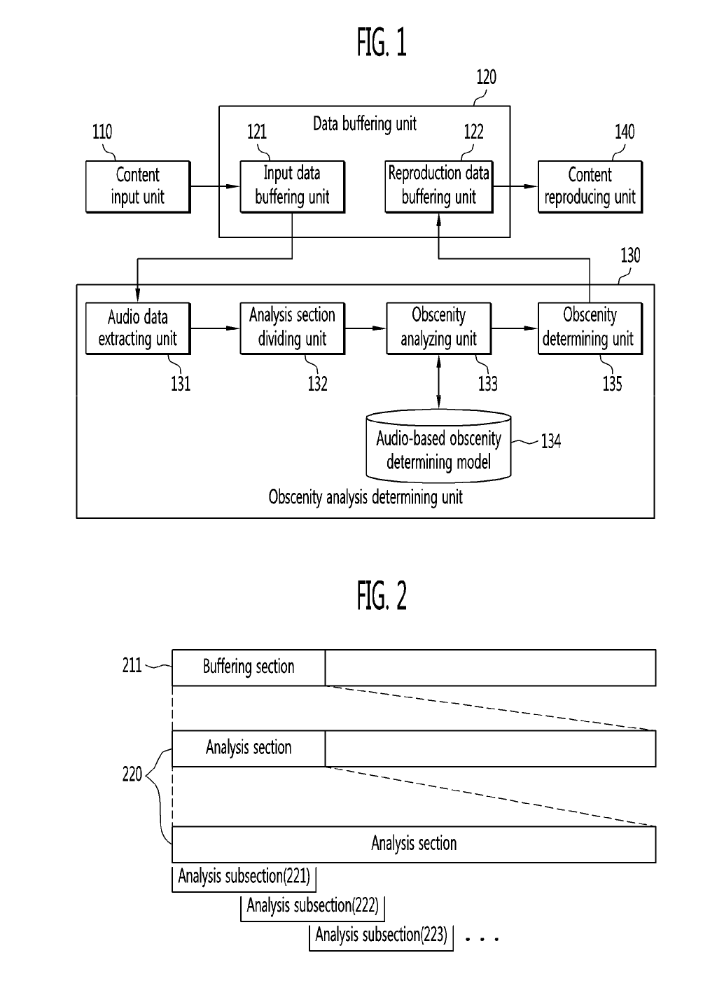

FIG. 1 is a configuration diagram illustrating an obscene content analysis apparatus based on audio data analysis according to an exemplary embodiment of the present invention. The obscene content analysis apparatus according to the exemplary embodiment of the present invention will be described with reference to FIG. 1.

As illustrated in FIG. 1, the obscene content analysis apparatus based on audio data analysis according to the exemplary embodiment of the present invention includes a content input unit 110, a data buffering unit 120, an obscenity analysis determining unit 130, and a content reproducing unit 140. The data buffering unit 120 includes an input data buffering unit 121 and a reproduction data buffering unit 122. The obscenity analysis determining unit 130 includes an audio data extracting unit 131, an analysis section dividing unit 132, an obscenity analyzing unit 133, an audio-based obscenity determining model 134, and an obscenity determining unit 135.

The content input unit 110 receives the content, and the input data buffering unit 121 buffers the content that corresponds to the length of a previously set analysis section or a length longer than the analysis section. The analysis section has the length that can be analyzed at once by the obscenity analysis determining unit 130. In the case in which the input data buffering unit 121 buffers the content corresponding to the length longer than the analysis section, analysis and reproduction on obscenity of the content can be more stably performed.

The obscenity analysis determining unit 130 extracts audio data from the buffered content. It is determined whether or not the analysis section of the extracted audio data is obscene in units of analysis subsections through a previously produced audio-based obscenity determining model. If the number of times that the analysis subsections in the analysis section are determined as obscene exceeds a previously set value, the analysis section is marked with an obscenity mark.

A configuration of the obscenity analysis determining unit 130 will be described below in further detail.

The audio data extracting unit 131 extracts audio data from the buffered content.

The analysis section dividing unit 132 divides the analysis section of the audio data into analysis subsections. The analysis section is referred to as a predetermined audio data section divided for analysis in the obscenity analyzing unit 133, and the analysis subsection is referred to as a section into which the analysis section is sub-divided for analysis of the audio data. The analysis subsections may be superimposed on each other. The obscenity analyzing unit 133 can reduce more determination errors when the subsections are superimposed on each other.

The obscenity analyzing unit 133 determines whether or not the analysis subsection is obscene through the audio-based obscenity determining model 134.

The audio-based obscenity determining model 134 is configured to extract audio features representing obscenity from obscene audio data and perform obscenity determination learning on the audio features. The audio-based obscenity determining model 134 is used as a criterion of determining obscenity of the audio data.

The obscenity determining unit 135 may mark the analysis section with the obscenity mark when the analysis section is determined as obscene. Alternatively, the obscenity determining unit 135 may accumulate the number of times that the analysis sections are determined as obscene, and when the accumulated value exceeds a previously set value, the obscenity determining unit 135 may determine the analysis section as an obscene section and mark the analysis section with the obscenity mark.

The reproduction data buffering unit 122 accumulates and stores the contents in which the obscenity value has been computed by the obscenity analysis determining unit 130. Since the reproduction data buffering unit 122 accumulates and stores the contents, even when the contents are analyzed faster than the reproduction speed of the content reproducing unit 140, reproduction of the contents is not interrupted or delayed.

The data buffering unit 120 may be configured with a single module that functions as both the input data buffering unit 121 and the reproduction data buffering unit 122. Alternatively, the data buffering unit 120 may be configured with two separate modules that function as the input data buffering unit 121 and the reproduction data buffering unit 122, respectively.

The content reproducing unit 140 reproduces the content. The content reproducing unit 140 reproduces the content while blocking the analysis section with the obscenity mark at a time when the reproduced content includes the analysis section with the obscenity mark. Thus, the content reproducing unit 140 blocks the obscene part of the content and reproduces the content without delay or interruption of the content.

The content reproducing unit 140 may display information representing that the content is the obscene content before or during reproduction of the content, and thus the user can recognize whether or not the content is obscene and whether or not the obscene part of the content is blocked through the information.

For example, when the content input unit 110 receives the content and the input data buffering unit 121 buffers the input content by the length of the analysis section or the length longer than the analysis section, the audio data extracting unit 131 extracts the audio data from the buffered content. The analysis section dividing unit 132 divides the analysis section of the audio data into the analysis subsections. The obscenity analyzing unit 133 determines whether or not the analysis subsection is obscene by using the audio-based obscenity determining model 134. The obscenity determining unit 135 accumulates the number of times that the analysis subsections are determined as obscene and generates the accumulated value. When the accumulated value exceeds a previously set reference value, the obscenity determining unit 135 determines the analysis section as the obscene section and marks the analysis section determined as the obscene section with the obscenity mark. The reproduction data buffering unit 122 buffers the content in order to reproduce the content whose obscenity has been analyzed without delay, and the content reproducing unit 140 reproduces the content while blocking the analysis section marked with the obscenity mark.

FIG. 2 is a view for explaining a method of dividing the analysis section into the analysis subsections and analyzing the obscene content according to an exemplary embodiment of the present invention.

An analysis section 220 of audio data extracted from a buffering section 211 of content is divided into a plurality of analysis subsections 221 to 223. The analysis section is referred to as a section set to have the length which can be analyzed at once, and the buffering section 211 has the same length as the analysis section or the length longer than the analysis section. In the case in which the buffering section 211 has the length longer than the analysis section 220, since the buffering section 211 is divided into a plurality of the analysis sections 220, and then analysis is performed on the analysis sections 220, the analysis can be continuously performed by the obscenity analysis determining unit 130. Thus, since the content analyzed at the speed faster than the reproduction speed thereof is accumulated and stored in the reproduction data buffering unit 122, the content can be more stably reproduced.

The analysis section 220 can be more efficiently and accurately analyzed and determined by dividing the analysis section 220 into the analysis sub sections 221 to 223. For example, obscenity of each of the analysis subsections 221 to 223 that constitute the analysis section 220 is determined, and when the number of the analysis subsections 221 to 223 determined as obscene exceeds a previously set number, the analysis section 220 is determined as the obscene analysis section.

In order to reduce determination errors, the analysis section 220 may be divided into the analysis subsections 221 to 223 in a superimposed manner, and the analysis subsections 221 to 223 may be analyzed to determine obscenity. When the analysis section 220 is divided into the analysis subsections 221 to 223 in the superimposed manner and then analysis is performed on the analysis subsections 221 to 223, obscenity of each of the analysis sections 220 is doubly analyzed, whereby obscenity can be more accurately determined.

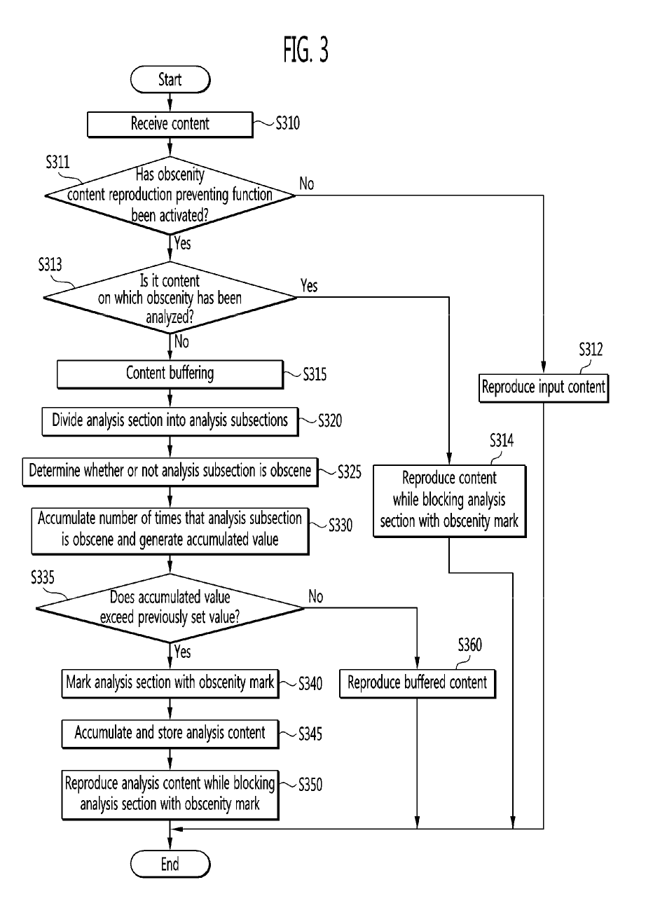

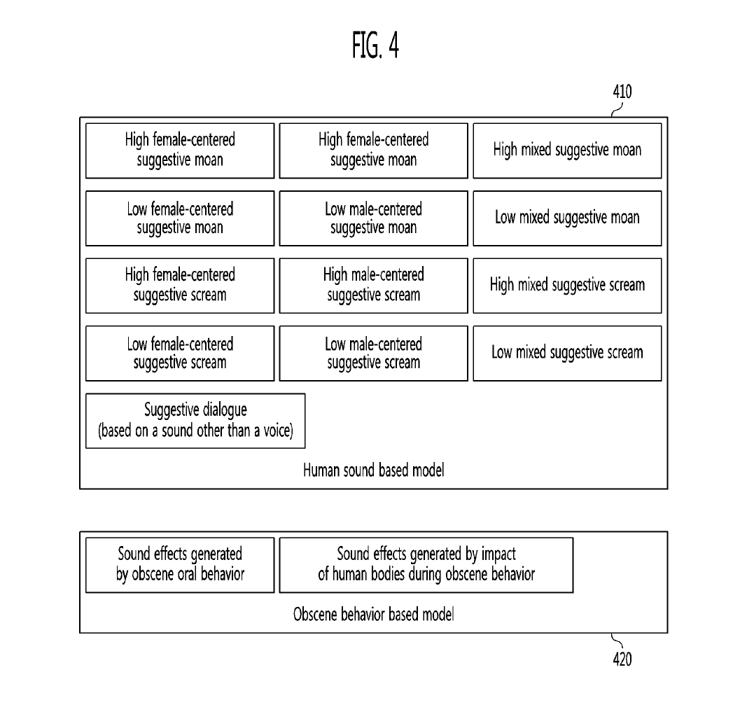

FIG. 3 is a flowchart for explaining an obscene content analysis method based on audio data analysis according to an exemplary embodiment of the present invention. The obscene content analysis method according to the exemplary embodiment of the present invention will be described below with reference to FIG. 3.

The obscene content analysis apparatus based on audio data analysis receives the content (S310) and determines whether or not execution of the obscene content reproduction preventing function has been activated (S311).

When execution of the obscene content reproduction preventing function has not been activated, the obscene content analysis apparatus reproduces the input content without performing obscenity analysis on the input content (S312).

When execution of the obscene content reproduction preventing function has been activated, the obscene content analysis apparatus determines whether or not the content is the content in which obscenity has been previously analyzed (S313). When the content is the content in which obscenity has been previously analyzed, the obscene content analysis apparatus checks an obscenity determination mark of the content without performing the distinct analysis process. When the section has the obscenity mark, the obscene content analysis apparatus blocks the section having the obscenity mark from being reproduced, and when the section does not have the obscenity mark, the obscene content analysis apparatus reproduces the section normally (S314).

When the content is the content in which obscenity has not been previously analyzed, buffering corresponding to the previously set length of the analysis section or the length longer than the analysis section is performed on the input content (S315).

Thereafter, the obscene content analysis apparatus based on audio data analysis divides the analysis section of the audio data extracted from the input content into the analysis subsections (S320) and determines obscenity of the analysis subsections by using the audio-based obscenity determining model (S325).

The obscene content analysis apparatus based on audio data analysis accumulates the number of times that the analysis subsections are determined as obscene and generates the accumulated value (S330), and determines whether or not the accumulated value exceeds a previously set value (S335).

When the accumulated value exceeds the previously set value, the obscene content analysis apparatus based on audio data analysis determines the analysis section as the obscene section and marks the analysis section with the obscenity mark (S340).

Then, the obscene content analysis apparatus based on audio data analysis accumulates and stores the content on which the obscenity value has been computed (S345).

The obscene content analysis apparatus based on audio data analysis reproduces the content while blocking the analysis section marked with the obscenity mark (S350). At this time, the obscene content analysis apparatus based on audio data analysis may display information representing that the content is the obscene content before or during reproduction of the content.

However, when the accumulated value does not exceed the previously set value, the obscene content analysis apparatus based on audio data analysis reproduces the content buffered in operation S315 as is without marking the analysis section with a distinct mark (S360).

FIG. 4 is a configuration diagram of the audio-based obscenity determining model according to an exemplary embodiment of the present invention.

The audio-based obscenity determining model is configured to extract the audio features representing obscenity from obscene audio data and perform obscenity determination learning on the audio features. The audio-based obscenity determining model is used as a criterion of determining obscenity of the audio data. The audio-based obscenity determining model defines and separates each audio component so that audio data-based features can be classified from the obscene content for higher obscenity determination performance. Using the audio-based obscenity determining model, audio data having an obscenity feature on which learning has not been performed can be determined as obscene.

As illustrated in FIG. 4, the audio-based obscenity determining model is classified into a human sound based model 410 that uses human hounds generated by human and an obscene behavior based model 420 that uses sound effects generated by obscene behaviors.

In the human sound based model 410, the human sounds are greatly classified into a suggestive scream and a suggestive moan which are also sub-classified into low and high according to the intensity thereof. The human sounds may be classified into male, female, and mixed according to a subject who generates the sound. Also, suggestive dialogue may be generated during obscene behavior. For the suggestive dialogue, voice recognition is too high in system load or too large in lingual dependence and thus is not realistic. Thus, the suggestive dialogue is classified as a feature of the obscenity determining model through an approach using sound feature recognition other than voice recognition.

In the obscene behavior based model 420, the sound effects are classified into sound effects generated by impact of human bodies during sexual intercourse and sound effects generated by oral behavior. The two types of sound effects are the sound effects which are most frequently generated.

The above described embodiments of the present invention may be implemented by various methods. For example, the embodiments may be implemented using hardware, software, or a combination thereof. In the case of software implementation, software may be executed on one or more processors using various operating systems or platforms. Additionally, software may be created by using any one of appropriate programming languages and may comply with a machine code or an intermediate code that is executable in a framework or a virtual machine.

Further, when the present invention is executed on one or more computers or other processors, the present invention may be implemented as a computer readable record medium (for example, a computer memory, one or more floppy disks, a compact disk, an optical disk, a magnetic tape, or a flash memory) in which one or more programs executing a method of implementing the above described various embodiments of the present invention is recorded.

As described above, according to the present invention, it is possible to provide the obscene content analysis apparatus and method based on audio data in which audio data of content is divided into sections, it is determined whether or not the sections are obscene, and the section determined as obscene is marked with an obscenity mark. Thus, it is possible to provide the content in real time while blocking the parts of the content with the obscenity mark during reproduction of the content.

Further, according to the present invention, unobscene parts of content can be selectively provided since a single content may have both obscene parts and unobscene parts.

Furthermore, when the obscene content analysis apparatus and method based on audio data analysis according to the present invention is applied to a multimedia player, it can be determined whether or not the content is obscene before reproduction of the content, and thus reproduction of obscene content can be blocked in advance. Also, when the obscene content analysis apparatus and method based on audio data analysis according to the present invention are applied to an upload module in a content service site, it can be automatically checked whether or not the content is obscene, leading to reduced human cost.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An obscene content analysis apparatus based on audio data analysis, the apparatus comprising:
a content input unit that receives content;
an input data buffering unit that buffers the received content, wherein buffering is performed on content corresponding to a length of a previously set analysis section or a length longer than the analysis section;
an obscenity analysis determining unit that determines whether or not the analysis section of audio data extracted from the buffered content is obscene by using a previously generated audio-based obscenity determining model and marks the analysis section with an obscenity mark when the analysis section is determined as obscene;
a reproduction data buffering unit that accumulates and stores content in which obscenity has been determined by the obscenity analysis determining unit; and
a content reproducing unit that reproduces the content while blocking the analysis section marked with the obscenity mark.

2. The obscene content analysis apparatus according to claim 1, wherein the obscenity analysis determining unit comprises:
an audio data extracting unit that extracts audio data from the buffered content;
an obscenity analyzing unit that determines whether or not the analysis section of the extracted audio data is obscene by using the audio-based obscenity determining model; and
an obscenity determining unit that marks the analysis section with the obscenity mark when the analysis section is determined as obscene.

3. The obscene content analysis apparatus according to claim 2, further comprising an analysis section dividing unit that divides the analysis section into analysis subsections,
wherein the obscenity analyzing unit determines whether or not each of the analysis subsections is obscene by using the audio-based obscenity determining model, and
the obscenity determining unit accumulates the number of times that the analysis subsections are determined as obscene and generates an accumulated value, and determines that the analysis section is obscene and marks the analysis section with the obscenity mark when the accumulated value exceeds a previously set value.

4. The obscene content analysis apparatus according to claim 1, wherein the content reproducing unit displays information representing that the content is obscene content.

5. The obscene content analysis apparatus according to claim 1, wherein the audio-based obscenity determining model is configured by extracting audio features of obscene audio data and performing obscenity determination learning.

6. The obscene content analysis apparatus according to claim 5, wherein the audio-based obscenity determining model comprises a human sound based model and an obscene behavior based mode,
the human sound based mode comprises at least one of a high female-centered suggestive moan, a low female-centered suggestive moan, a high female-centered suggestive scream, a low female-centered suggestive scream, a high male-centered suggestive moan, a low male-centered suggestive moan, a high male-centered suggestive scream, a low male-centered suggestive scream, a high mixed suggestive moan, a low mixed suggestive moan, a high mixed suggestive scream, a low mixed suggestive scream, and a suggestive dialogue sound that is based on a sound other than a voice, and
the obscene behavior based model comprises at least one of sound effects generated by obscene oral behavior and sound effects generated by an impact of human bodies during obscene behavior.

7. A method of analyzing obscene content based on audio data, the method comprising:
receiving content;
buffering the received content, wherein buffering is performed on content corresponding to a length of a previously set analysis section or a length longer than the analysis section;
extracting audio data from the buffered content;
determining whether or not the analysis section of the audio data extracted from the content is obscene by using a previously generated audio-based obscenity determining model;
marking the analysis section with an obscenity mark when the analysis section is determined as obscene;
accumulating and storing content in which obscenity has been determined; and
reproducing the content while blocking the analysis section marked with the obscenity mark.

8. The method claim 7, wherein determining whether or not the analysis section of the audio data extracted from the content is obscene by using a previously generated audio-based obscenity determining model comprises:
dividing the analysis section in analysis subsections; and
determining whether or not each of the analysis subsections is obscene by using the audio-based obscenity determining model.

9. The method claim 8, wherein marking the analysis section with an obscenity mark when the analysis section is determined as obscene comprises:
accumulating the number of times that the analysis subsections are determined as obscene and generating an accumulated value; and
determining that the analysis section is obscene and marking the analysis section with the obscenity mark when the accumulated value exceeds a previously set value.
